(19) United States
(12) Patent Application Publication
(10) Pub. No.: US 2009/0199687 A1
(43) Pub. Date: Aug. 13, 2009

(54) DEVICE FOR THE MANUFACTURE OF ABSORBENT PRODUCTS

(75) Inventors: Thomas Bohm, Vastra Frolunda (SE); Daniel Carlsson, Molndal (SE)

Correspondence Address: DRINKER BIDDLE & REATH (DC), 1500 K STREET, N.W., SUITE 1100, WASHINGTON, DC, 20005-1209, US

(73) Assignee: Sca Hygiene Products AB, Goteborg (SE)

(21) Appl. No.: 12/304,242

(22) PCT Filed: Jun. 30, 2006
(86) PCT No.: PCT/SE2006/000813

§ 371 Date: Dec. 10, 2008

(51) Int. Cl. B26F 1/20; B26D 1/22

(52) U.S. Cl. 83/332; 83/505; 83/508.3

(57) ABSTRACT

A device for the manufacture of an absorbent product including a rotatable slitting tool having an extent in a radial direction and an extent in an axial direction perpendicular to the radial direction. The slitting tool includes a cutting part including a plurality of cutting edges having a first radius and intermediate parts situated between the cutting edges at a smaller distance from the axial center line of the slitting tool than the cutting edges. The device includes a force-absorbing means arranged to absorb forces from an abutment roller at least when the intermediate parts in the slitting tool pass the abutment roller.

### CROSS-REFERENCE TO PRIOR APPLICATION

This application is a §371 National Stage Application of PCT International Application No. PCT/SE2006/000813 filed Jun. 30, 2006.

### FIELD OF THE INVENTION

The invention relates to a device for the manufacture of an absorbent product comprising a rotatable slitting tool having an extent in a radial direction and an extent in an axial direction perpendicular to the radial direction. The slitting tool comprises a cutting part comprising a plurality of cutting edges having a first radius and present between the cutting edges intermediate parts situated at a smaller distance from the axial center of the slitting tool than the cutting edges.

### BACKGROUND OF THE INVENTION

The expression absorbent products is used here to denote diapers, sanitary towels, panty liners and incontinence articles.

Previously disclosed are a large number of processes for the manufacture of absorbent products, and a feature common to all these processes is the desire to achieve the highest possible rate of production. One way of achieving a high rate is to arrange the production facility in such a way that a continuous process is obtained, in which a plurality of material webs is brought simultaneously and continuously to different process stations for slitting, cutting, stretching of the material, shrinking, joining, etc., in order finally to obtain the finished product. The manufacture of an absorbent product is thus subject to special conditions, which means that the process is difficult to compare with another process, for example in the case of the manufacture of automobile components or in the ready-made garments industry.

The execution of slits in a layer of material by causing the layer of material to pass between a slitting tool and an abutment roller, which rotate in opposite directions relative to one another, is already familiar in the manufacture of absorbent products. The abutment roller has a circular cross section, and the slitting tool has a cutting edge which includes intermittently raised parts intended for cutting or perforating the layer of material.

The raised parts are pressed against the abutment roller in order for the cutting edge to produce its effect through the layer of material and, in this way, to bring about the desired slits.

One problem associated with the prior art is that the intermittently raised parts cause vibrations when the rollers rotate against one another, because the slitting tool does not have a circular cross section, and consequently give rise to unequal pressure during rotation. The vibrations have the disadvantage that the manufacturing facility can only operate at a limited speed, because other parts of the machine and suspensions would otherwise be exposed to the risk of being shaken apart or affected by fatigue problems. A further disadvantage is that the wear on the slitting tool is considerable because that part of the cutting edge which first enters into engagement, after a period when the slitting tool is not in engagement with the abutment roller, is required to take up all the force unaided, which shortens the service life of the knife blade.

A wish and a need accordingly exist for an improved device and manufacturing process for slitting layers of material in conjunction with the manufacture of absorbent products.

### BRIEF SUMMARY OF THE INVENTION

The object of the present invention is to solve the above problem, which problem is solved by means of a device intended for the manufacture of an absorbent product in accordance with the accompanying claim 1.

The device in accordance with the invention comprises a rotatable slitting tool having an extent in a radial direction and an extent in an axial direction perpendicular to the radial direction. The slitting tool comprises a cutting part comprising a plurality of cutting edges having a first radius, and present between the cutting edges intermediate parts situated at a smaller distance from the axial center of the slitting tool than the cutting edges. The invention is characterized in that the device comprises a force-absorbing means so arranged as to absorb forces from an abutment roller when the intermediate part passes the abutment roller.

One advantage of the invention is that the force-absorbing means essentially prevents a change in pressure between the slitting tool and the abutment roller at the point of transition between the cutting edges and the intermediate parts. The problem of vibrations is thus reduced or eliminated by the force-absorbing means.

According to one embodiment of the invention, the device comprises a shaft on which the slitting tool is arranged. The force-absorbing means comprises at least two carrier rings having essentially the same radius as the first radius, which carrier rings are positioned to either side of the slitting tool and on the same shaft as the slitting tool. The carrier rings are so arranged as to absorb forces from the abutment roller, in particular when the intermediate part passes the abutment roller.

One advantage of the carrier rings is that they have a constant radius which, when it comes into contact with an abutment roller, rolls with the abutment roller and in so doing equalizes the changes in pressure which, during rotation of the slitting tool, would otherwise have arisen between the slitting tool and the abutment roller on passing the cutting edges and the intermediate parts respectively of the slitting tool.

The carrier rings lie on approximately the same radius as the cutting edges and thus constitute support surfaces for the slitting tool during that part of the rotation for which the slitting tool does not perform any slitting. The carrier rings can have a radius that is greater than, equal to or smaller than the radius of the slitting tool at the cutting edges. The reason why the radius of the carrier rings may vary depends on, among other things, the choice of material for the constituent component parts of the device, the width of the cutting edges, and the type of processing that is required, as well as the desired service life of the slitting tool. The stronger the contact between the slitting tool and the abutment roller, the shorter the service life. The choice of material determines how the constituent component parts of the device expand in the presence of generated heat, for which reason it may be necessary to change the radii of the carrier rings in order to make allowance for this. The differences in radius between the carrier rings and the slitting tool are in the order of micrometers, however, for which reason the carrier ring and slitting tool radii can be regarded as being essentially identical when compared with the prior art, where the differences between the radius of the edges and the intermediate parts can be in the order of millimetres and centimetres.

In conjunction with slitting in accordance with the invention, the edges roll on essentially the same radius as the carrier rings, which means that the problems that are already known to arise in a transitional zone between parts with different radii are avoided entirely. Vibrations are avoided by the constant radius of the carrier rings, and a higher process rate can be maintained. The service life of the slitting tool also increases dramatically and, under optimal conditions, the slitting tool can have a service life corresponding to that of a circular slitting knife with a constant cutting edge. The carrier rings are positioned on the shaft in such a way that the material to be processed by the slitting tool runs between the carrier rings. The carrier rings are thus in direct contact with the abutment roller at all times.

Slitting can be fully or partially through going in the layer of material, and slitting can be performed by crushing the material or by cutting. In the case of crushing, the slitting tool makes contact with a cylindrical abutment roller with the layer of material positioned in between, and where the layer of material is moving at the same speed as the slitting tool. In the case of cutting, the layer of material has a different relative speed compared with the peripheral speed of the cutting edges. In conjunction with cutting, the slitting tool makes contact with an abutment roller of the kind described above, or with another slitting tool embodied in the same manner as the first, where the cutting edges of both slitting tools are in contact with one another. By using two slitting tools, cutting can be achieved by causing the cutting edges of the two slitting tools to lie displaced in a radial direction in relation to one another and to be synchronized in such a way that they do not cut into the material when an abutment is absent.

In conjunction with the manufacture of an absorbent product, it is sometimes desirable to execute slits in a layer of material, as mentioned above. The slits can provide tear indications, fold indications and can impart air permeability and liquid permeability to an airtight material. The layer of material is then passed in accordance with the invention between the slitting tool and an abutment roller, which rotate relative to one another in opposite directions. The abutment roller has a circular cross section, and the slitting tool comprises the cutting edges and the intermediate parts mentioned above. When the narrower cutting edges are caused to rotate against the abutment roller, the combination of the pressure of the slitting device against the abutment roller and the small width of the cutting edges results in cuts being made in the layer of material, in conjunction with which the slits are formed.

According to one embodiment of the invention, the slitting tool is manufactured from a cylindrically shaped disc, where a circumferential cutting edge is created by removing material from the envelope surface of the cylinder in such a way that only the cutting part remains. Material is then removed from the cutting part in such a way that the intermediate parts are formed.

According to another embodiment of the invention, the slitting tool is manufactured by moulding the desired form. Finishing operations, such as turning, grinding and polishing, may be carried out.

According to a further embodiment of the invention, the slitting tool is manufactured from a blank, which possesses a different width in a central zone than in an external (in the radial direction) peripheral zone. The peripheral zone contains the cutting edges and can be manufactured according to one of the embodiments mentioned above. The central zone can possess a greater width than the peripheral zone, but it can also possess a smaller width.

The device according to the invention can comprise a plurality of slitting tools arranged adjacent to one another in the axial direction. All the sitting tools can then act against the same abutment roller or against a plurality of abutment rollers. The different slitting tools can have the same diameter or different diameters. When the slitting tools have the same diameter and act against a cylindrical abutment roller with a constant diameter, all of the slitting tools exert the same pressure against the abutment roller. If the cutting edges of the different slitting tools also possess the same width and form, slits with an identical appearance will result. When the slitting tools have different diameters, the slitting tools exert different pressures against an abutment roller with a constant diameter. The different pressures can give rise to slits with a different appearance, for example different depths in a layer of material. This effect can also be achieved by the different slitting tools having different diameters, but where the abutment roller also has different diameters for the different slitting tools.

The slitting tool and the abutment roller can be caused to rotate at the same peripheral speed, that is to say the relative speed at the contact surface between the slitting tool and the abutment roller is equivalent to zero.

As an alternative, the slitting tool and the abutment roller can be caused to rotate at different peripheral speeds, which results in the cutting edges having a higher or lower speed relative to the abutment roller and thus the layer of material, as a consequence of which the slitting tool processes the layer of material both by pressure and by cutting.

The slitting tool, the abutment roller and the carrier rings can be manufactured from, for example, steel, carbide, ceramic materials or other suitable materials. The slitting tool can have a diameter of between 2 centimetres and 1 meter. The distance between the carrier rings and the slitting tool can vary depending on the characteristics and the diameter of the shaft and the pressure exerted on the shaft by the various component parts. This distance should preferably be of a size such that the shaft does not flex during use.

The layer of material can include any material that is suitable for use in an absorbent product. An absorbent product can comprise a top layer, a backing layer and between them an absorption body. The absorbent product can also comprise a receiving layer positioned between the top layer and the absorption body. The layer of material can have a thickness between 10 micrometers and 1 centimetre. The slitting tool can thus be used on one or other of these layers of material, but it is exemplified below in conjunction with the manufacture of a top layer.

The direction of the slits depends on a number of factors, such as the direction of movement of the web of material during the slitting operation and the choice of material for the top layer. It can be mentioned here by way of example that a slit will open when it is subjected to forces that are oriented at an angle away from the direction in which the slit extends. The natural tendency for the slit to open is at its greatest when the forces act upon the slit in a direction oriented at 90° to the direction in which the slit extends. The top layer is manufactured in a web of material having a movement in a machine direction which, in the finished product, can coincide with the longitudinal direction of the absorbent product or its lateral direction. In conjunction with its manufacture, the web of material is influenced by forces in the machine direction which cause slits which lie perpendicular to the machine direction to be influenced to a maximum extent by these forces. The forces involved in this case can cause the material to split at the slits or, at any rate, can cause the slits to open essentially permanently. Furthermore, the finished absorbent product will contain slits having an extent either in the longitudinal direction or in the lateral direction, which will mean that the slits are affected essentially only by forces from one direction. If the slits are instead oriented at an angle to the machine direction, the slits will lie at an angle to a longitudinally extending center line, which from the point of view of process technology presents a smaller risk of the top layer splitting, and which from the point of view of the product imparts a shape to the slits that is affected by forces both from the lateral direction and from the longitudinal direction and at angles in between. The comparisons indicated above apply to slits with a given length. The fact that the slits are affected by forces in the lateral direction and in the longitudinal direction, and at angles in between, means that the natural tendency of the slits to open and close as the wearer moves will increase, because movement by the wearer gives rise to forces both in the lateral direction and in the longitudinal direction and in directions in between.

The slits themselves can be straight, S-shaped, V-shaped, Z-shaped, U-shaped, or can exhibit any other suitable shape. The slits can also comprise combinations of different shapes, for example a plurality of straight or curved slits arranged in a row. The straight slits can be arranged in the absorbent product with the same or a different length, where every other slit is oriented at an angle (preferably essentially 90°) in relation to the preceding slit, but where the slits are situated at a distance from one another. The slits are thus present at an angle of between 0 and 180° relative to a longitudinally extending center line, preferably in the range from 20°-65° and/or 110°-155° in relation to the longitudinally extending center line. The curved slits can have parts that are angled in relation to one another and to the center line. The cutting edges are given a corresponding shape to form the above-mentioned slits, and as a result the manufacture of the slitting tool is more complicated than in the case of a straight cutting edge of the kind described above as being most advantageous from the manufacturing point of view. However, the cutting edges may be oriented in the direction of rotation or at an angle to the direction of rotation, depending on the desired shape of the slits.

The absorption body is manufactured from a suitable fiber material, in the form of natural or synthetic fibers having absorbent properties, or a mixture of natural fibers and synthetic fibers or other absorbent materials of a previously disclosed kind that are suitable for use in sanitary towels, incontinence pads and panty liners, for example. The absorption body can also contain a predetermined proportion, for example 20-60%, of superabsorbent materials, that is to say polymer materials in the form of particles, fibers, flakes or similar, which have the ability to absorb and to chemically bind liquid equivalent to several times their own weight while forming an aqueous gel. This provides a very high water-absorbent capacity in the finished product.

The absorption body can exhibit different forms, for example an essentially elongated and rectangular form, or alternatively some other more irregular form, for example hourglass or triangular. The absorption body also preferably has rounded edges.

The liquid-permeable top layer preferably includes the same material or a combination of the following materials: a fibrous material, for example a soft nonwoven material, although alternatively it can include other materials or material laminates. The top layer is preferably fully or partially perforated, that is to say slits are made in the top layer as described above, and holes can be present in the wet area. The top layer can appropriately include a perforated plastic film, for example a thermoplastic plastic material such as polyethylene or polypropylene, or a mesh-like layer of synthetic or textile material. Synthetic fibers, such as polyethylene, polypropylene, polyester, nylon or the like, are used by preference as a nonwoven material. Mixtures of different types of fibers can also be used for the aforementioned nonwoven material. In addition to nonwoven material, the top layer can also include the processing of other materials, for example films made of thermoplastics such as polyethylene or polypropylene.

The invention can also be implemented with a top layer which includes different types of laminates or combinations of laminates and/or single layers. For example, the top layer can include a number of different laminates or single layers which cover parts of the surface of the product. In the event that the product includes a plurality of laminates or single layers, for example divided up into a plurality of longitudinal sections having different sections, these different sections can include different materials and can exhibit different characteristics. For example, each section can then have different types of perforation, hole positioning, dimensions, hydrophobicity, etc. The different sections can be joined together by means of ultrasonic welding in a previously disclosed manner that is not described here in detail.

The liquid-permeable top layer is preferably manufactured from a material that exhibits characteristics such as dryness and softness during the time when the absorbent product is being worn, because this top layer is in contact with the wearer's body. It is also desirable for the top layer to have a soft and textile-like surface which remains dry, even in the event of repeated wetting. The top layer can include a nonwoven material, for example, with a soft and smooth surface, such as a spunbond material made from polypropylene fibers. A perforated, hydrophobic nonwoven material may be used in order to permit the surface that is closest to the wearer's body to be kept dry, in conjunction with which holes are formed in the material that are larger than the distance between the fibers in the material. In this way, liquid can be led down through the holes in the top layer to the subjacent absorption body. Other examples of materials for the top layer are perforated plastic films, such as a perforated polyester film. The top layer can be joined together with the subjacent backing layer and the absorption body, for example by means of adhesive, ultrasonic joining or by means of some form of thermal bonding.

The top layer can also be a three-dimensional laminate of nonwoven and plastic film or a carded, thermally bonded material based 100% on polypropylene. The plastic film can be hydrophilic, pre-perforated (with small holes) and manufactured from a mixture of polyethylene and polypropylene. The nonwoven materials can have a weight per unit area in the range from 12-100 gsm, and in particular in the range from 15-60 gsm.

The nonwoven part of the top layer can also be a spunbond nonwoven material, an air-thru nonwoven material, a spunlace nonwoven (hydroentangled) material, a meltblown nonwoven material, or a combination of these. The raw material can be polypropylene (PP), polyethylene (PE) polyester (PET), polyamide (PA), or a combination of these. If a combination is used, this can be a mixture of fibers from different polymers, although each fiber can also contain different polymers (e.g. PP/PE bi-component fibers or PP/PE copolymers). Where appropriate, the plastic film can include PE or PP, PET, PLA or amyl (or any other thermoplastic polymer), or a mixture or copolymers of the aforementioned polymers.

The perforated top layer can also be manufactured from a single layer of material, such as a nonwoven material or a film (as described above).

The holes in the top layer can be oval and slightly elongated in the direction of the machine. The holes can be round/circular or oval in the direction of the machine or the transverse direction. The holes in the wet area can also be replaced by slits, which by definition differ from the holes in that the slits do not constitute constant openings, but instead are through going incisions in the layer of material. The slits are opened and closed by movement in the material.

According to one example of a top layer, the slits are preferably from 2 mm up to 15 mm in length, and preferably lie in the range from 3-10 mm. The length of the slits is measured along the boundary surfaces of the slits in a direction essentially perpendicular to the thickness of the top layer and when the slit is in its closed state.

The slits are arranged in the top layer with a mutual distance between the slits having a size in the order of 5-15 mm, although this is dependent on a range of factors, for which reason the distance between the slits can vary depending, among other things, on the material in the top layer and the length of the slits and the direction of the slits. This distance between the slits should be sufficiently great to prevent the top layer from being torn apart when the wearer moves, and sufficiently great to allow the slits to close in the desired manner without the influence of other slits, although at the same time it should be sufficiently small for the ability to breathe and the liquid permeability to PATENT remain at an acceptable level. The durability of the top layer is largely governed, however, by the relationship between the surface containing slits and the surface without slits for a given material strength, where the distance between the slits is a subset of the parameters for the durability. The length of the slits and the distance between the slits and the direction of the slits vary depending on the material in the top layer, because the natural tendency of the slits to open depends on the characteristics of the material present in the top layer.

The backing layer is preferably liquid-impermeable (or at least possesses high resistance to penetration by liquid) and is thus so arranged as to prevent any leakage of excreted fluid from the product. The backing layer, on the other hand, may be executed so that it is vapour-permeable. For this purpose, the backing layer may be manufactured from a liquid-impermeable material which includes appropriately a thin and liquid-proof plastic film. For example, plastic films of polyethylene, polypropylene or polyester can be used for this purpose. Alternatively, a laminate of nonwoven and plastic film or other suitable layers of materials can be used as a liquid-proof backing layer. In a previously disclosed manner, the under side of the backing layer can be provided with beads of adhesive or some other previously disclosed attachment means, which can then be utilized for the application of the product to an item of clothing. The product can also be provided with wings, that is to say folding flaps which, in a previously disclosed manner, are arranged along the sides of the product and can be utilized in conjunction with the application of the product.

The product can also include a further layer of material in the form of a receiving layer (also referred to as an acquisition layer, an admission layer and a distribution layer, depending on the function of the material). The receiving layer can be in the form of a wadding material having an appropriately specified thickness and resilience, which is intended to be positioned between the absorption body and the top layer. The receiving layer possesses essentially the same dimensions as the top layer, with the exception of its thickness, however, which can deviate from the thickness of the top layer. It is also possible to establish that the receiving layer can include materials other than wadding material. For example, it may include a so-called airlaid material, which is usually based on cellulose fibers. The receiving layer can also incorporate fibrous materials in order to impart an appropriately balanced rigidity to it. The admission layer can also incorporate an appropriate quantity of thermoplastic fibers in order to permit ultrasonic welding.

The receiving layer can appropriately be a porous, elastic, relatively thick layer of material, for example in the form of a fibrous wadding material, a carded fiber wadding, a tow material, or some other kind of bulky and/or resilient fiber material with a high instantaneous liquid intake capacity that is capable of storing liquid temporarily before it is absorbed by the subjacent absorption body. The receiving layer can also be in the form of a porous foam material. It can also include two or more layers of material. According to a preferred embodiment, the receiving layer can extend towards the lateral edges of the product, that is to say it possesses essentially the same form as the top layer. In this way, advantages can be achieved in respect of liquid distribution, edge sealing, etc.

The choice of material and the thickness and the density of the layer of material may change in the future in the event of changed manufacturing methods and new material combinations, as a consequence of which the invention is not restricted to the materials and material combinations indicated above.

When manufacturing the absorbent product, the top layer is joined to the backing layer and can also be joined to the receiving layer and/or the absorption body. Joining can take place by gluing; or by welding by means of ultrasonic or laser; or by mechanical joining, for example in the form of embossing or compression, etc., or by some other appropriate method of joining, for example thermal bonding.

According to one embodiment of the invention, the device comprises a joining device for the above joining process. The joining device can comprise a device for a thermal bonding process, for example an ultrasonic welding device, or a mechanical joining process in the form of embossing or compression with hot and/or cold rollers, etc. The joining device advantageously comprises a tool, for example an ultrasonic horn, and a pattern embossed continuously or discontinuously on the abutment roller in the form of one or a plurality of raised parts. The pattern is arranged at a predetermined distance from the slitting tool. The joining device influences the layer of material in a direction towards the raised parts, for example by means of pressure, heat and, possibly, vibrations at a predetermined frequency, in conjunction with which heat is generated in the material, which gives rise to a weld, or embossing, or the like, depending on the quantity of energy transmitted by the joining device to the layer of material. One advantage of such a device is that the welded joint or the embossing, etc., ends up at a reproducibly exact distance from the slits. In previously disclosed joining devices, the welding takes place at a separate work station remotely from the slitting, which gives rise to problems with the adaptation of the piece of material to be processed in order to obtain a welded joint or the like at a desired distance from a slit.

### BRIEF DESCRIPTION OF THE DRAWINGS

The invention is described below in conjunction with a number of Figures, in which:

FIG. 1 depicts schematically a side view of a slitting tool in accordance with the invention;

FIG. 2 depicts schematically a view from the front of the slitting tool according to a first embodiment of the invention;

FIG. 3 depicts schematically a view from the front of the slitting tool according to a second embodiment of the invention;

FIG. 4 depicts schematically a side view of a device for the manufacture of an absorbent product comprising the slitting tool according to FIGS. 1-3, where the slitting tool performs a slitting operation in a layer of material;

FIG. 5 depicts schematically a view of the device according to FIG. 4 from the line A-A in FIG. 4;

FIG. 6 depicts schematically a side view of a device for the manufacture of an absorbent product according to FIG. 4, but where the slitting tool is in a position in which slitting of the layer of material does not occur;

FIG. 7 depicts schematically a view of the device according to FIG. 4 from the line A-A in FIG. 6; and where

FIG. 8 depicts schematically a view from the line A-A of the device according to FIG. 4 according to an embodiment in which the device also comprises an ultrasonic device.

### DETAILED DESCRIPTION OF THE PREFERRED EMBODIMENTS

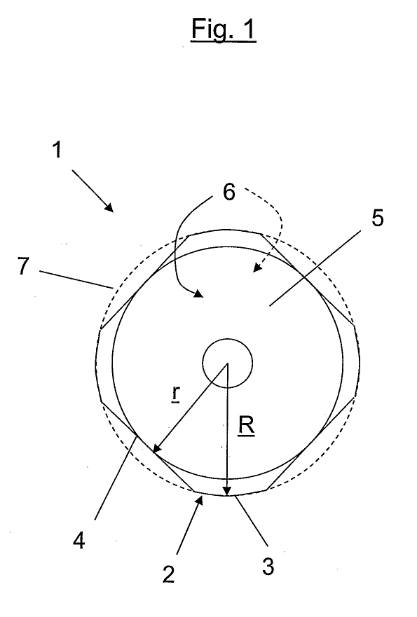

FIG. 1 depicts schematically a side view of a rotatable slitting tool 1 according to the invention. The Figure shows that the slitting tool 1 has an extent in a radial direction and an extent in an axial direction perpendicular to the radial direction. The slitting tool 1 comprises a cutting part 2 comprising a plurality of cutting edges 3 having a first radius R and present between the cutting edges 3 intermediate parts 4 situated at a smaller distance r from the axial center of the slitting tool 1 than the cutting edges 3. FIG. 1 shows a central zone 5 having an extent coaxially in an axial direction along the entire width of the slitting tool, and having an extent in the direction radial to the intermediate parts 4. The central zone is delimited in the radial direction by two opposing lateral surfaces 6.

The slitting tool 1 is manufactured from an essentially cylindrical blank that has been processed in such a way that selected parts of the blank have been removed, for example by grinding, milling or similar suitable operations for metalworking. The part of the blank remaining after processing comprises the edges 3 and the intermediate parts 4. FIG. 1 shows with a dotted line 7 the original cutting part 2 before the start of processing for the intermediate parts 4. The original cutting part 2 has been manufactured by grinding a cylindrical blank on either side, in conjunction with which a circumferential cutting part 2 has been formed along the dotted line 7. The original cutting part 2 has an essentially constant radius and will thus perforate/slit a layer of material throughout its entire rotation, that is to say it will give rise to a constant slit. This is not desirable in the case of intermittent slitting, and a series of slit and unprocessed parts is sought. According to the invention, the slitting tool 1 is subjected to further processing for this reason in such a way that a part of the cutting part is removed by appropriate processing in such a way that the intermediate parts 4 are formed. This method of manufacturing a slitting tool is simple and inexpensive and is to be preferred. One problem, however, is that the intermediate parts 4 are unable to roll on the same radius as the cutting edges 3, as a result of which vibrations occur when the slitting tool is rolled against a cylindrical abutment roller with a constant radius, which causes wear to the machines and the slitting tool 1.

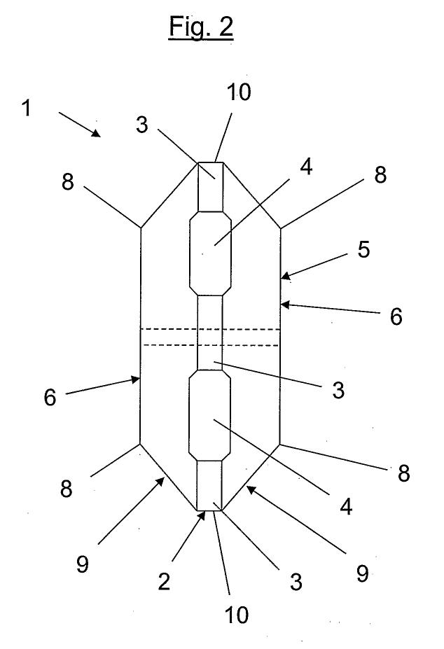

FIG. 2 depicts schematically a view from the front of the slitting tool according to a first embodiment of the invention. FIG. 2 shows that the cutting edges 3 are narrower than the intermediate parts 4, and that the slitting tool 1 has a central zone 5 that is broader than both of the cutting edges 3 and the intermediate parts 4. FIG. 2 shows that the cutting part comprises lateral parts 9, which exhibit an extent from the outer edge 8 of the central zone 5 in the respective lateral surfaces 6 to the outermost parts 10 of the edges 3 in the radial direction. The outer parts of the cutting edges 3 are illustrated in FIG. 2 with an essentially plane embodiment in the axial direction. The outer parts of the cutting edges 3 are not restricted to such an embodiment, but can possess different widths, for example convex, triangular or having some other appropriate form. FIG. 2 shows the lateral parts 9 with a plane cross section viewed in the axial direction.

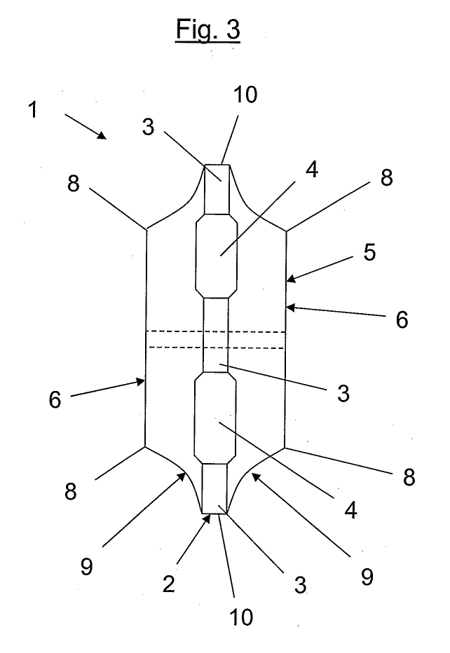

FIG. 3 depicts schematically a view from the front of the slitting tool according to a second embodiment of the invention. FIG. 3 shows the same situation as FIG. 2, with the difference that the lateral parts 9 comprise a curved surface having an essentially convex cross section viewed in the axial direction.

The slitting tool 1 is illustrated in FIGS. 1-3 as a cylindrical unit, in which the lateral surfaces 6 are plane and parallel. The slitting tool 1 in accordance with the invention is not restricted to such plane lateral surfaces 6, however, but can have concave or convex lateral surfaces 6.

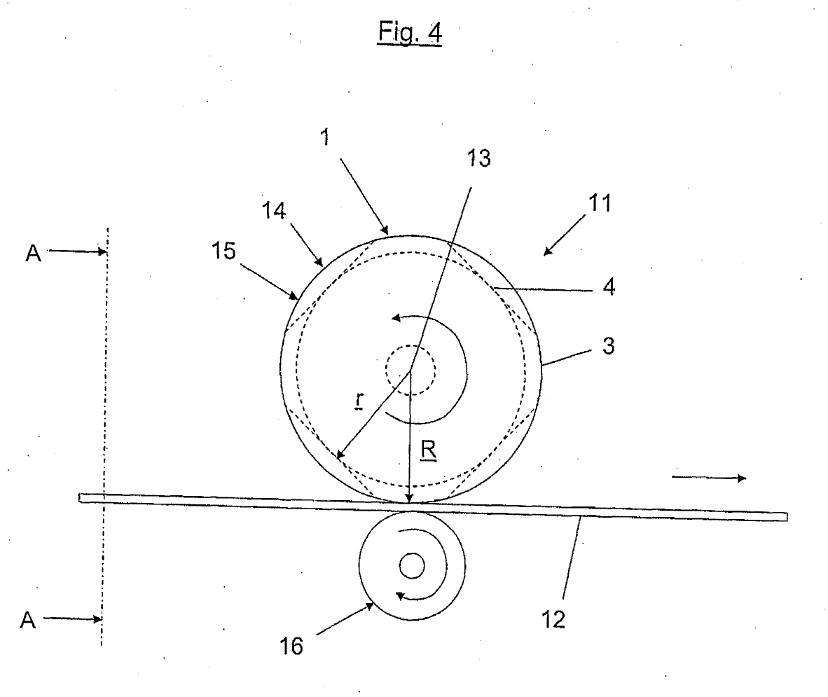

FIG. 4 depicts schematically a side view of a device 11 for the manufacture of an absorbent product comprising a slitting tool 1 according to FIGS. 1 and 2 or 1 and 3, where the slitting tool 1 performs a slitting operation on a layer of material 12. The device 11 comprises a shaft 13, on which the slitting tool 1 is arranged. The device additionally comprises a force-absorbing means 14 comprising at least two carrier rings 15 having the same radius R as the first radius R. The carrier rings 15 are positioned to either side of the slitting tool 1 and on the same shaft 13 as the slitting tool 1.

The device 11 comprises an abutment roller 16 which rotates in the opposite direction compared with the slitting tool 1. The directions of rotation of the two units are indicated in the Figure with arrows. The Figure also shows that the layer of material 12 is arranged between the slitting tool 1 and the abutment roller 16. The layer of material 12 is made of a suitable material for use in absorbent products. FIG. 4 shows that a cutting edge 3 processes the layer of material 12 during rotation of the slitting tool 1 and the abutment roller 16. The layer of material 12 moves in the direction of the arrow, and the movement coincides with the rotational movement of the slitting tool 1 and the abutment roller 16. The carrier rings 15 are so arranged as to absorb forces from the abutment roller 16 in that they have a constant radius essentially identical to the radius R of the slitting tool 1, which, when it comes into contact with the abutment roller 16, rolls with the abutment roller and in so doing equalizes the changes in pressure which, during rotation of the slitting tool, would otherwise have arisen between the slitting tool 1 and the abutment roller 16 on passing the respective intermediate parts 4 and the cutting edges 3.

The device 11 can be driven in various ways. The abutment roller can be connected to a drive device and is able through its rotation to drive the layer of material 12 in its direction of movement. In one embodiment, the slitting tool 1 lacks a connection to a drive device and is only supported about a shaft. The layer of material 12 transfers its movement to the slitting tool 1 through friction in this case. In another embodiment, the slitting tool 1 is connected to a drive device which imparts a rotation to the slitting tool. The abutment roller 16 in one embodiment is able to rotate here at the same peripheral speed as the slitting tool 1, in which case the layer of material 12 is driven at the same speed and is slit during rotation of the slitting tool 1. The abutment roller 16 in another embodiment is able to rotate at a different peripheral speed than the slitting tool 1, however, in which case the relative difference in speed gives rise to a shearing force in the layer of material 12, which enables the cutting edges to cut through the layer of material 12.

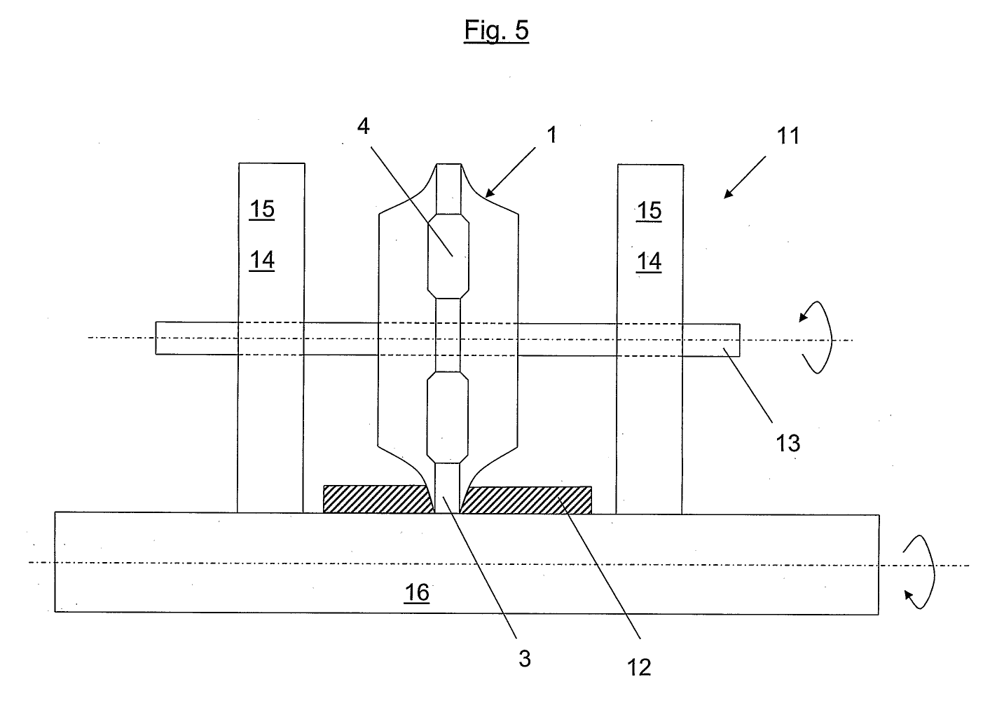

FIG. 5 depicts schematically a view of the device 11 according to FIG. 4 from the line A-A in FIG. 4. FIG. 5 depicts the layer of material 12 as a sectioned view, in which a cutting edge 3 of the slitting tool 1 is in contact with the abutment roller 16 with a pressure such that the cutting edge 3 has parted the layer of material 12. The parting can depend on crushing or cutting. This is a question of definition, which depends on the sharpness of the cutting edge, that is to say its width, and the pressure that has been established between the slitting tool 1 and the abutment roller 16, as well as the characteristics of the layer of material. The narrower the cutting edge 3, the more easily it is able to cut through the layer of material 12, although a high pressure can compensate for a blunt cutting edge 3 by crushing the layer of material 12. The characteristics of the layer of material 12 include, for example, the type of bonds which hold together the layer of material in its longitudinal extent and the thickness of the layer of material 12.

FIGS. 4 and 5 show that the carrier rings 15 are in direct contact with the abutment roller 16, in conjunction with which the layer of material 12 is positioned between the two carrier rings 15.

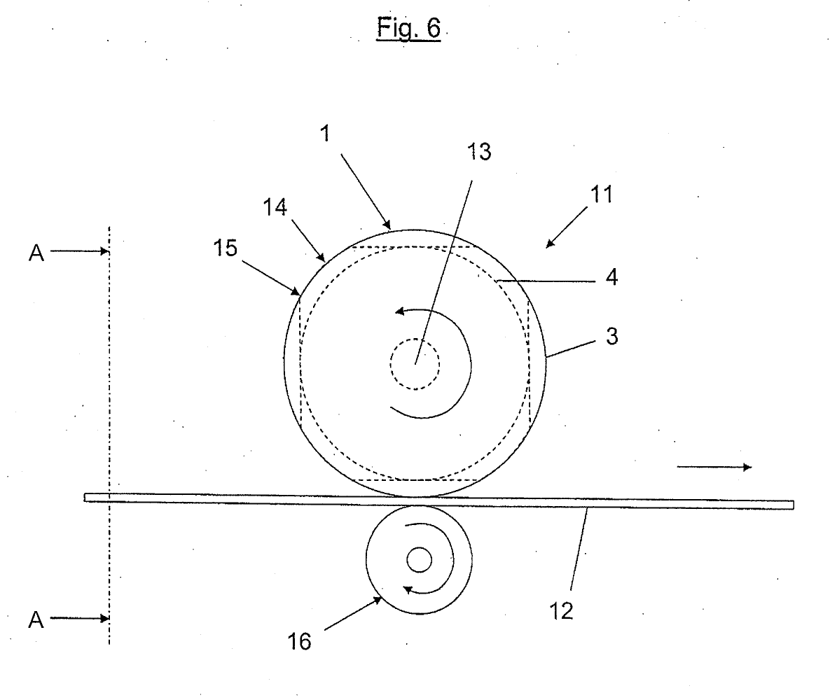

FIG. 6 depicts schematically a side view of a device 11 for the manufacture of an absorbent product according to FIG. 4, but where the slitting tool 1 is in a position in which slitting of the layer of material 12 does not occur. FIG. 6 depicts the slitting tool 1 in a position in which an intermediate part 4 faces towards the layer of material 12.

The carrier rings 15 which lie on essentially the same radius as the cutting edges 3 thus constitute supporting surfaces for the slitting tool 1 for that part of the rotation during which the slitting tool 1 does not perform any slitting. During the slitting operation, the cutting edges 3 roll on essentially the same radius as the carrier rings, which means that the previously disclosed problems which arise in a transitional zone between parts with different radii are avoided entirely. Vibrations are avoided by the constant radius of the carrier rings 15, and a higher process rate can be maintained. The service life of the slitting tool 1 also increases dramatically and, under optimal conditions, can have a service life corresponding to that of a circular slitting knife with a constant cutting edge.

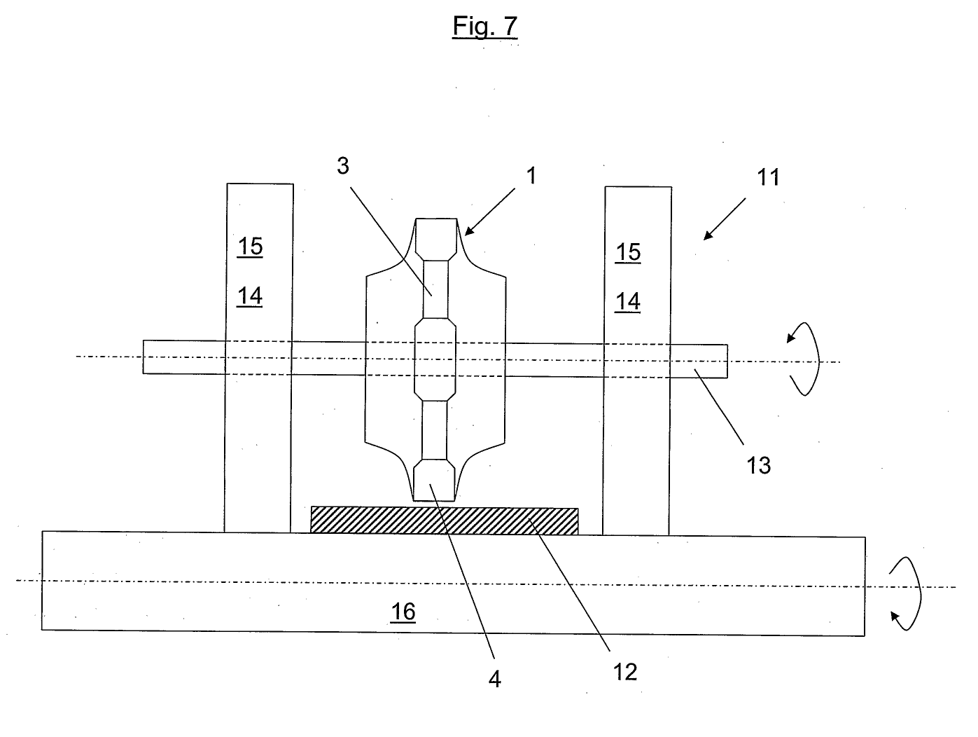

FIG. 7 depicts schematically a view of the device 11 according to FIG. 6 from the line A-A in FIG. 6. FIG. 4 shows that the carrier rings 15 make contact with the abutment roller 16 when the intermediate part 4 passes the abutment roller 16, in conjunction with which the carrier rings 15 absorb forces from the abutment roller 16 via the layer of material 12. FIG. 7 shows that the layer of material 12 is not influenced by the slitting tool 1 when the intermediate parts 4 pass the layer of material 12, unlike the case when the cutting edge 3 passes. This is because the carrier rings 15 have a larger radius than the intermediate parts 4, as a consequence of which the intermediate parts 4 are unable to press against the layer of material 12 with such force that slitting takes place.

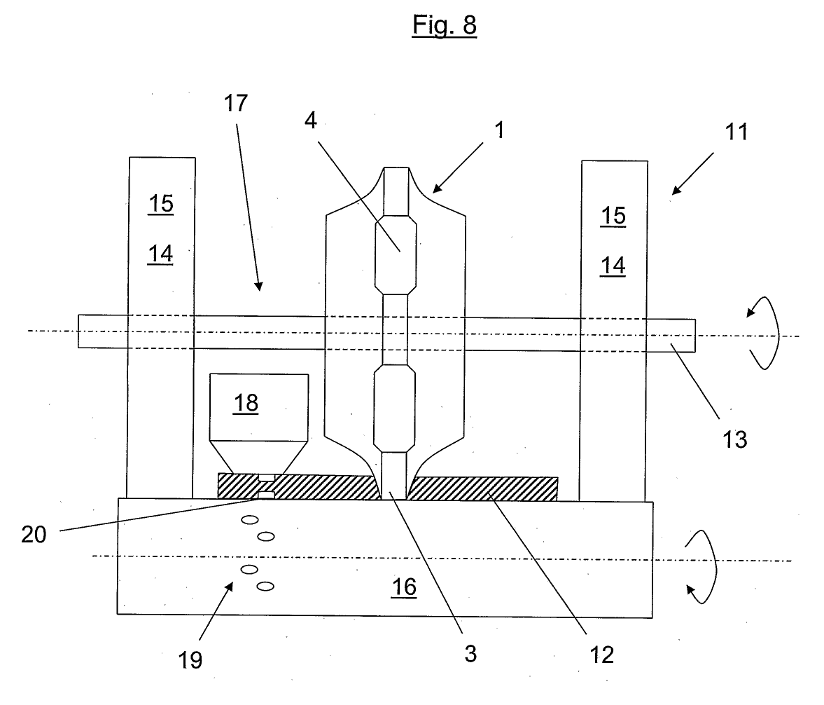

FIG. 8 depicts schematically a view from the line A-A of the device 11 according to FIG. 4 according to an embodiment of the invention in which the device also comprises a joining device in the form of an ultrasonic device 17. The ultrasonic device 17 comprises an ultrasonic horn 18 and a pattern embossed on the abutment roller in the form of raised parts 19. In FIG. 8, the pattern 19 is arranged at a predetermined distance from the slitting tool 1. The ultrasonic device 17 affects the layer of material 12 in that the ultrasonic horn 18 exerts pressure and vibrates at a frequency against the layer of material 12 and the raised parts 19, in conjunction with which heat is generated in the material, which gives rise to a weld or embossing or the like, depending on the quantity of energy transmitted by the ultrasonic device 17 to the layer of material. FIG. 8 shows that the ultrasonic device has produced embossing 20 in the layer of material 12. One advantage of this embodiment is that the embossing 20 ends up at exactly the same distance from the slit parts in the layer of material 12 for the entire duration of the continuous process, because the raised parts 19 are positioned at a predetermined distance from the slitting tool 1.

1. A device for the manufacture of an absorbent product, comprising a rotatable slitting tool having an extent in a radial direction and an extent in an axial direction perpendicular to the radial direction, the slitting tool comprising a cutting part comprising a plurality of cutting edges and intermediate parts between the cutting edges, wherein the distance between the intermediate parts and the axial center line of the slitting tool is less than the distance between the cutting edges and the axial center line of the slitting tool, and wherein the device comprises a force-absorbing means arranged to absorb forces from an abutment roller at least when the intermediate parts in the slitting tool pass the abutment roller.

2. The device according to claim 1, wherein the device comprises a shaft on which the slitting tool is arranged.

3. The device according to claim 2, wherein the force-absorbing means comprises at least two carrier rings having essentially the same radius as the first radius.

4. The device according to claim 3, wherein the carrier rings are positioned to either side of the slitting tool and on the same shaft as the slitting tool.

5. The device according to claim 1, wherein each cutting edge has a width which permits slitting of a layer of material intended for an absorbent product.

6. The device according to claim 1, wherein the device comprises a plurality of slitting tools positioned next to one another in the axial direction.

7. The device according to claim 1, wherein the slitting tool is manufactured by obtaining an essentially cylindrical disc, removing material from the envelope surface of the cylinder so that only a cutting part remains, and removing portions of the cutting part to form intermediate parts between remaining cutting edges.

8. The device according to claim 1, wherein the slitting tool is manufactured by molding the slitting tool followed by a step of finishing the slitting tool to create the cutting edges and the intermediate parts by turning, grinding, polishing, or a combination thereof.

9. The device according to claim 1, wherein the slitting tool is manufactured from a blank having, in the radial direction, a central zone and external peripheral zone, wherein the central zone possesses a width in the axial direction that differs from the width in the external peripheral zone, and wherein the external peripheral zone contains the cutting edges.

10. The device according to claim 1, wherein the slitting tool has a diameter of between 2 centimeters and 1 meter.

11. The device according to claim 1, wherein the device further comprises a joining device, the joining device comprises a tool and a pattern in the form of one or a plurality of raised parts embossed continuously or discontinuously on the abutment roller, wherein the tool transmits a quantity of energy to a layer of material in the direction of the raised parts to change the structure of the layer of material.
